(19) United States
(12) Patent Application Publication
(10) Pub. No.: US 2011/0090489 A1
(43) Pub. Date: Apr. 21, 2011

(54) Method and Apparatus for Detecting Small Reflectivity Variations in Electronic Parts at High Speed

(76) Inventor: Robert Bishop, Newton, MA (US)

(21) Appl. No.: 12/908,786

(22) Filed: Oct. 20, 2010

Related U.S. Application Data
(60) Provisional application No. 61/253,566, filed on Oct. 21, 2009.

(51) Int. Cl. G01N 21/00

(52) U.S. Cl. 356/237.1

(57) ABSTRACT

A method and apparatus for performing high speed automatic optical inspection of electronic parts such as wafers, flat panel displays, ITO on PET or glass, multi chip modules, and high-density electronic packages. The method and apparatus identify and distinguish different materials on a part by increasing image contrast for each material without increasing electronic noise by processing the image signal with high optical gain and low electrical gain. As a result, the method and apparatus identify different materials, variations in the materials, and defect locations when the materials have similar reflectivities.

### CROSS REFERENCE TO RELATED APPLICATION

This application claims priority from U.S. Provisional Patent Application Ser. No. 61/253,566 filed Oct. 21, 2009 for a Method and Apparatus for Detecting Small Reflectivity Variations in Electronic Parts at High Speed.

### BACKGROUND OF THE INVENTION

1. Field of the Invention

This invention generally relates to the optical inspection of electronic parts for manufacturing defects and more particularly to an inspection that identifies defects when two adjacent materials have similar reflectivities.

2. Description of Related Art

The inspection of electronic parts such as wafers, flat panel displays, structures with indium tin oxide (ITO) on polyethylene terephthalate (PET) or glass, multi-chip modules, and high-density electronic packages requires an ability to identify and distinguish different materials on a part. Prior art methods and apparatus operate effectively when the optical characteristics including reflectivity of each different material are significantly different. However, in some electronic parts, such as those made with ITO, the optical characteristics including reflectivity of different material layers are not significantly different. Prior art apparatus and methods do not provide the required inspection of such parts with a quality and inspection speed now demanded by the industry.

What is needed is a new optical inspection method and apparatus that can distinguish different materials with similar optical characteristics and can operate at the speeds industry now requires.

### SUMMARY

Therefore, it is an object of this invention to provide a method and apparatus for performing optical inspections on parts with different materials having similar optical characteristics.

Another object of this invention is to provide a method and apparatus for performing optical inspections at high speeds with a high throughput on parts with different materials having similar reflectivities.

In accordance with this invention, with this invention it is possible to undertake optically inspection of an electronic part with first and second materials each independently reflecting light with a high signal-to-noise ratio, but with similar reflectivity characteristics, each material being further characterized by exhibiting small variations in reflectivity caused by defects in that material. The electronic part is illuminated in at least an area to be imaged and relative motion between the electronic part and an imaging station occurs during scanning. An image signal is generated at the imaging station in response the reflected light using high optical gain and low electrical gain thereby to produce a high-gain, low-noise image signal that is distinctive for light reflected from each of the first and second materials. This high-gain, low-noise image signal is processed by subtracting an offset signal having a value based upon the reflectivity of the material with the lesser reflectivity characteristics thereby to generate n-bit digital values representing 2ⁿ intensity levels of the desired output image that distinguish between reflections from each of the materials and that detect defects in the electronic part.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a plot of camera image intensities for two different materials having similar optical characteristics;

FIGS. 2A and 2B are useful in understanding the operation of a specific camera used in practicing this invention;

FIG. 3 depicts differences in camera output for two different materials with similar optical reflectivities after certain processing in accordance with this invention

FIG. 4 depicts differences in camera output for another set of two different materials with similar optical reflectivities; after certain processing in accordance with this invention.

FIGS. 5 and 6 depict two different embodiments for implementing a portion of this invention; and

FIG. 7 depicts an image obtained using the method and apparatus of this invention.

### DESCRIPTION OF ILLUSTRATIVE EMBODIMENTS

This invention enables the optical inspection of electronic parts for defects with first and second materials, each independently reflecting light with high signal to noise, but with extremely similar reflectivity characteristics. Signals from such materials cannot be distinguished from each other when viewed by a conventional TV or CCD camera because the difference in reflectivity lies within the noise of the image acquiring apparatus.

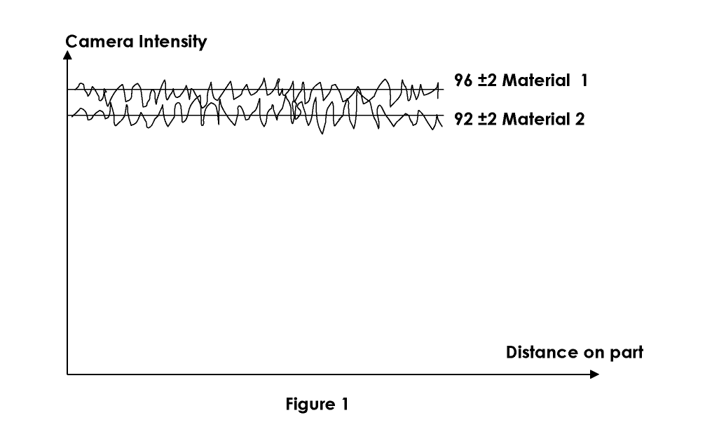

This invention will be understood best by considering an example in which two materials on the same part produce signals with nominal camera intensity values of 92 and 96 respectively as shown in FIG. 1. Assume that electronic camera noise is +/−2 counts. As shown in FIG. 1, each material independently has a high signal-to-noise ratio (SNR). However, it is impossible to distinguish one material from the other because both materials can produce the same camera output value of 94 due to electronic noise in the system. This invention describes a process by which it is possible to identify materials with extremely small differences in reflectivity and to detect variations within each material as the part is scanned and inspected at production speeds with sufficient resolution to detect small defects in each material.

Camera or image signal output, or intensity, for a given material is given by:

Cam_{sig}≈[(ILLUMINATION*OE*REF*IntegrationTime*NA²*K)+Noise]*Eg (1)

where:
(1) ILLUMINATION=total illumination power incident on the part within the camera field of view,
(2) OE=transmittance of the optical system,
(3) REF=the percent of illuminated light reflected from the material and is given by:

$$R E F = \frac{REFLECTED - LIGHT - INTENSITY}{ILLUMINATION - LIGHT - INTENSITY} \qquad ( 2 )$$

(4) IntegrationTime=time duration over which light is collected by the camera,
(5) NA=the numerical aperture of the imaging optics,
(6) K=optical power to electronic signal conversion constant for the camera,
(7) NOISE=electronically introduced noise of the camera electronics when viewing a dark field, and
(8) Eg=electronic gain or amplification.

Equation 1 can be expressed in terms of an optical gain (Og) and electronic gain Eg, such that:

Cam_{sig}=[REF*Og+Noise]*Eg (3)

where:

Og=ILLUMINATION*OE*NA²*IntegrationTime*K (4)

The difference in camera signal (Cam_{diff}) between two materials with reflectivities REF₁ and REF₂, respectively, is given by:

Cam_{diff}≈[Og*(REF₁−REF₂)±2*Noise]*Eg (5)

Letting N=2*Noise in equation (5) yields:

Cam_{diff}≈[Og*(REF₁−REF₂)±N]*Eg (6)

From equation (6) it is apparent that:
1. [Og*(REF₁−REF₂)]>N to distinguish the two materials having a minimum difference between their respective reflectivities;
2. [Og*(REF₁−REF₂)]>>N to determine variations within each materials;
3. Increasing electronic gain Eg increases the magnitude of noise in the camera output signal, and
4. Increasing electronic gain Eg does not improve the signal to noise ratio; that is:

$$S / N = \frac{[ Og * ( {REF}_{1} - {REF}_{2} ) ]}{N} \qquad ( 7 )$$

To achieve optimal performance it is desirable to set the electronic gain Eg=1 and maximize the optical gain Og such that:

[Og*(REF₁−REF₂)]>>N (8)

Satisfying this condition enables the detection of variations within each material. For example, to detect 256 intensity levels between Material 1 and Material 2:

[Og*(REF₁−REF₂)]>256*N (9)

From Equation (9) it will be apparent that optical gain (Og) as defined in Equation (4) is the only independent variable. Referring to Equation (4):

ILLUMINATION is the total illumination power incident on the part within the camera field of view. In applications where high power illumination is required to increase optical gain, lamp life becomes an issue. For example, frequently used halogen lamps or high pressure mercury vapor lamps are only rated for 200 hours of operation under normal operating conditions. It is not easy or cost effective to increase illumination power past the nominal power levels. While LED sources are also very popular, they do not yet produce as much intensity as the above mentioned lamps. Coherent lasers and laser diodes which can produce significant power are not applicable for most inspection applications because the coherence produces optical interference band artifacts in the image.

OE is the transmittance of the optical system. This is a function of optical coatings and filter characteristics. Optical coatings are usually optimized for the white light spectrum and do not need to be altered. Filter transmission characteristics usually vary between 80% for absorption type filters and 99% for interference filters. Interference filters are preferred if filters are required for the application.

NA² is the square of numerical aperture and represents a light collection coefficient of the lens. As optical gain, Og, is proportional to NA², the light collection coefficient is increased greatly by increasing the numerical aperture of the imaging optics.

Table 1 lists characteristics of several commercially available lenses with the magnification/pixel size, numerical aperture, light collection coefficient, light collection cone angle, resolving power, depth of focus and working distance for each lens.

TABLE 1
Commercially Available Objective Lenses

| | | | Light | Resolving Power | Depth of Focus | |
|---|---|---|---|---|---|---|
| | | | Collection | for λ = 0.55 | λ = 0.55 | Working |
| | Numerical | Light Collection | Cone Angle | (Microns) × NA | (Microns) | Distance |
| Magnification/ | Aperture | Coefficient | (degrees) | λ | λ | (WD) |
| pixel size (microns) | (NA) | (NA²) | θ = 2 × sin¹(NA) | 2̅ ×̅ N̅A̅ | 2̅ ×̅ N̅A̅²̅ | (mm) |
| 1.25x/10.4 | 0.035 | 0.0012 | 4.0 | 7.8 | 229 | 3.9 |
| 2.5x/5.2 | 0.075 | 0.0056 | 8.6 | 3.6 | 49 | 9.4 |
| 5x/2.6 | 0.15 | 0.0225 | 17 | 1.8 | 12.2 | 13.6 |
| 5x/2.6 | 0.25 | 0.0625 | 29 | 1.1 | 4.4 | — |
| 10X/1.3 | 0.25 | 0.0625 | 29 | 1.1 | 4.4 | 12.7 |
| 10X/1.3 | 0.30 | 0.0900 | 35 | 0.9 | 3.1 | 5.7 |
| 20X/0.65 | 0.40 | 0.1600 | 47 | 0.7 | 1.7 | 9.8 |
| 10X/1.3 | 0.50 | 0.2500 | 60 | 0.5 | 1.1 | 2.0 |
| 20X/0.65 | 0.50 | 0.2500 | 60 | 0.5 | 1.1 | 1.4 |

Thus, a high NA lens, such as the 10×0.5NA and 20×0.5NA lenses, collect 204 times more light than the 1.25×0.035 NA lens.

High NA lenses also provide a higher resolution. Resolving power is given by the Rayleigh equation, namely:

$$RESOLVING\_POWER = \frac{λ}{2 * NA} \qquad ( 10 )$$

where λ is the wavelength of light imaged onto the part. As shown in Table 1, the 1.25×0.035NA lens can only resolve 7.8 microns as compared to the 20×0.5 NA lens which can resolve 0.5 microns for λ=0.55 microns.

As also known and evident from Table 1, depth of focus (DOF) decreases with increasing NA, being given by:

$$D O F = \frac{λ}{2 * {NA}^{2}} \qquad ( 11 )$$

For example, the DOF for the 0.035NA lens is 229 microns. The DOF for the 0.3 NA lens is 3.1 microns. The depth of focus for the 0.5 NA lens is 1.1 microns.

To obtain the highest optical gain possible, one should incorporate the highest NA lens for which focus can be maintained during inspection. If a part is sufficiently flat, focus is not a problem. However, if a part is not sufficiently flat, the system must incorporate an auto-focus system that tracks the surface of the part to keep the imaging optics within the optical DOF during inspection; one such auto-focus system is described in my U.S. Pat. No. 7,015,445 (2006) for a Method for Optimizing Inspection Speed in Low and Fluorescent Light Applications without Sacrificing Signal to Noise, Resolution Or Focus Quality.

### Integration Time

In optical inspection systems to which this invention is directed, optical gain is proportional to integration time which, in turn, is a function of the type of camera used to scan the part and the scanning speed (i.e., the relative speed between the electronic part and an imaging station that includes the camera. As will now be shown, a line scan time delay and integrate (TDI) CCD camera in combination with high NA optics (NA>0.05) enables superior performance with much greater optical gain than can be achieved using Non-TDI line scan CCD cameras and area cameras. This can be shown by comparing performance achieved using the different types of cameras.

### Inspection Using an Area Camera

There are two modes for inspection using an area camera. In Mode 1 a part is placed on a mechanical stage. The stage is stepped in a checkerboard pattern with each step equal to or slightly smaller than the size of the area camera to insure overlap of each image field. At each location an image of the part is acquired using an integration time long enough to obtain sufficient signal. This method is extremely slow because the stage must mechanically settle after each step to prevent image blur. This method is not applicable for high speed production applications.

In Mode 2 the camera is continually scanned over the part and a fast strobe light is flashed when the camera is centered over each checkerboard square. To prevent image blur, the duration time of each flash, which is the effective integration time, must be less than the time in which the part moves 1 camera pixel across the array. If the flash time is longer multiple pixels will be blurred together. The faster the stage scans, the shorter the flash must be. Therefore integration time is very short in this mode and limits the maximum achievable optical gain of the system.

### Inspection Using a Line Scan CCD Camera

Line scan charge coupled device (CCD) cameras enable the part to be scanned on a continually moving stage using a constant intensity light source, such as a quartz halogen, xenon or mercury vapor arc lamp. Stage motion and camera readout of the data is synchronized usually by a position encoder on the stage. Each time the stage moves a distance equal to the size of the pixel on the camera divided by the optical magnification, one line of data is read out of the linear CCD camera. For high speed inspection applications, it is desirable to read out the data as fast as possible. The effective integration time is therefore equal to the fastest time the line of data can be read out of the CCD and is given by:

IntegrationTime=ReadoutTime=NumberOfCCDPixels*DataRate (12)

To achieve higher throughput some line scan cameras incorporate multiple outputs. For example if a camera were to have four 4 outputs each connected to one quarter of the pixels, data could be read out of all four outputs simultaneously, reducing inspection time by a factor of 4. However, faster readout rates imply shorter integration times which, as previously noted, reduce optical gain. Therefore such high speed inspection systems cannot inspect products such as ITO on PET or ITO on glass because such systems lack the required optical gain.

### Inspection Using a Time Delay and Integrate (TDI) Line Scan CCD Camera

A time delay and integrate (TDI) CCD camera can provide longer integration time, while still enabling objects to be scanned at high speeds using constant illumination. To understand how a TDI camera works, consider two cars C1 and C2 traveling parallel to each other at exactly the same high speed in adjacent lanes of a highway. A passenger in car 2 takes a picture of the driver in car 1. This requires opening the shutter of their camera for a few seconds. Since there is no relative motion between the two cars and thereby no relative motion between the camera in car 2 and driver in car 1, the picture of car 1 will be sharp and free of image blur.

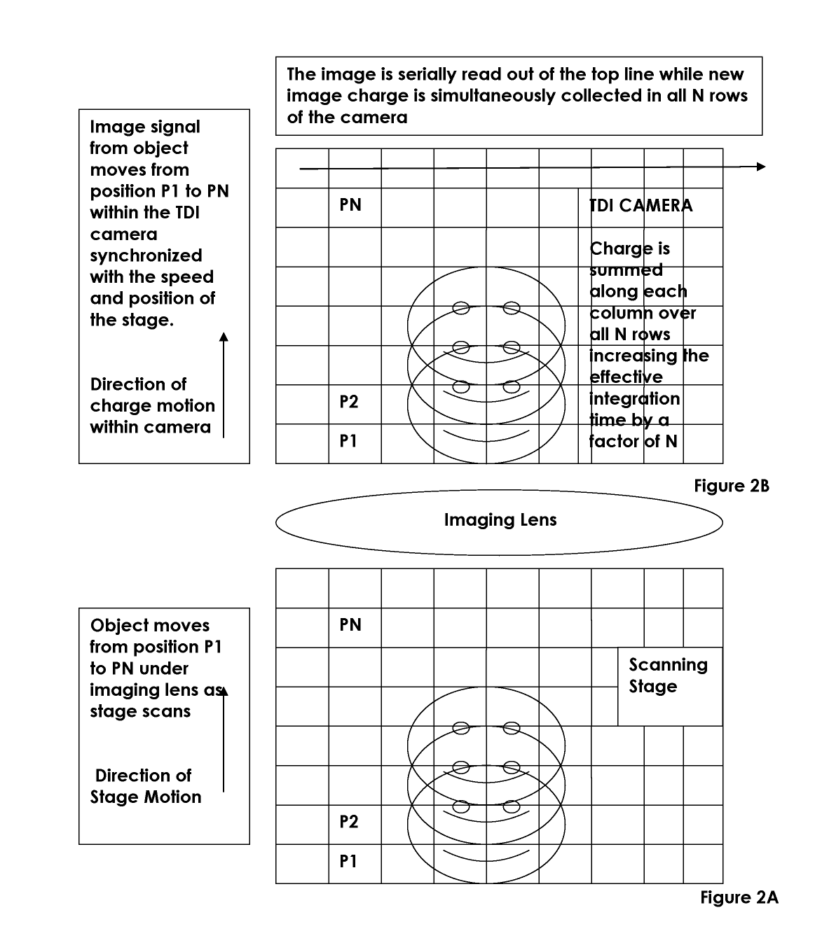

Consider an object moving on a stage below an imaging lens. As illustrated by the smiley face in FIG. 2B, the image of the face is projected onto a TDI CCD camera as shown in FIG. 2A. When the bottom of the face is in row position P1, on the stage and TDI camera, image charge is collected in every pixel in row 1 of the TDI camera. When the stage and image moves to row position P2, the line of charge collected in row position P1, for each camera pixel, is transferred into the same column position in row P2 within the TDI camera. Line P2 also contains image detectors, in each horizontal pixel position, that collect one line of charge which is summed with the line of charge transferred in from line P1 to create twice the image charge in each horizontal pixel position. Each row of the TDI camera contains image detectors that collect one line of charge that is added to the cumulative sum of charge from all previous lines.

By moving the charge or image within the TDI camera at the exact speed of the moving stage one can continue to collect light from the same physical point on the object without introducing any image blur because there is no relative motion between the object on the stage and image being transferred between rows within the TDI camera. While light is being collected in rows 1 through n of the camera, the image charge in the top row is sequentially read out of the device. If the TDI camera has n rows then, and the line scan and TDI camera have the same construction, the image read out of the TDI camera will contain n times more signal than the single line camera.

In practice, manufacturers of these cameras make various tradeoffs. For example, a manufacturer may sacrifice signal-to-noise ratios to achieve higher data rates. That is, consider an 8000-pixel, single-line scan camera with a maximum data rate of 320 MHZ and a light response of 44 digital counts/(nJ/cm²) at an electronic gain (Eg) of +10 db and an 8000-pixel TDI camera with 96 rows. It has a maximum data rate of 640 MHZ and a light response of 1170 digital counts/(nJ/cm²) with Eg=+10 db.

The different light responses between these two cameras can be expressed as different values of the optical power to electronic signal coefficient (K in equation (4)) for the two cameras. The first 96 row TDI camera is 26 times more sensitive than, and twice as fast as, the second, single line scan camera. Therefore K_{TDI}=(26/96)×K_{SLC}. This implies that if a given TDI camera produces a given output signal level with a 150 watt lamp, the single line scan camera will require 26 times that amount (i.e., 3900 watts) to produce the same output signal level. Lamps do not have this power. Moreover, directing light at such intensity on a part is likely to burn and destroy the part.

### Optimizing the Optical Gain

Integration time can be expressed as:

IntegrationTime=TDIRows*LineRate (13)
where
TDIRows is the number of TDI rows in the camera, and
LineRate is the time for each line to be read out of the CCD and
LineRate is given by:

LineRate=#Pixels*CK (14)
where
   #pixels is the number of camera pixels per camera output, and
   CK is the time per pixel.

Substituting equation (14) into equation (4) yields:

Og=ILLUMINATION*OE*NA²*TDIRows*LineRate*K (15)

Equation (15) indicates that TDI cameras will provide superior optical gain (Og). Assume the first system comprises a commercially available TDI camera with a lens in which NA=0.3 and DOF=3.1 microns which may be coupled with the auto focus system described in U.S. Pat. No. 7,015,445. Further, assume that the second system uses the single line scan camera in which NA=0.1 and DOF=27.5 microns. Table 2 below compares the light sensitivity for these two cameras:

TABLE 2

| | | Depth | | | Optical |
|---|---|---|---|---|---|
| Type of | | of Field | | | Gain |
| Camera | NA | (microns) | NA² | #TDI x K | Og |
| (96 row | 0.3 | 3.1 | .09 (9x) | 26x | 234x |
| TDI) | | | | | |
| Single | 0.1 | 27.5 | .01 (1x) | 1x | 1x |
| Line Scan | | | | | |

### Processing the Optical Image Signal

Referring to Table 2, assume two materials differ in reflectivity by 1 count with the 0.1 NA single line scan camera. With the 0.3 NA 96 row TDI line scan camera configuration, these same materials will differ by 234 counts, free of noise from electronic amplification The difference signal is computed by subtracting the two camera signals [Cam_{sig 1}−Cam_{sig 2}] obtained by viewing the two different materials at different times and at different spatial positions; that is:

Cam_{sig 1}≈[REF₁*Og+Noise]*Eg (16)

and

Cam_{sig 2}≈[REF₂*Og+Noise]*Eg (17)

While the difference in reflectivity between the two signals is small, the individual reflectivity of each material may be much greater as shown in FIG. 1. Therefore when these reflectivities are magnified by the large optical gain of this invention, the magnitude of each individual camera signal Cam_{sig-1} and Cam_{sig-2} respectively will be extremely large as shown in the following two examples:

In Example 1 it is assumed that images are taken with a 0.1 NA single line scan camera with Og=1×. In this example, Cam_{sig 1}=17 counts when viewing material 1 and Cam_{sig 2}=16 counts when viewing material 2. For a 0.3 NA TDI camera with Og=234×, Cam_{sig 1}=3978 counts when viewing material 1 and Cam_{sig 2}=3744 counts when viewing material 2.

In Example 2 it is assumed that images are taken with a 0.1 NA single line scan camera with Og=1×. In this example, Cam_{sig 1}=250 counts when viewing material 1 and Cam_{sig 2}=251 counts when viewing material 2. For the 0.3 NA TDI camera with Og=234×, Cam_{sig 1}=58,734 counts when viewing material 1 and Cam_{sig 2}=58,500 counts when viewing material 2.

Referring to Examples 1 and 2, a camera with 256 grey scale levels (8 bits) can image materials 1 and 2 using the 0.1NA line scan camera. However there is no discrimination between the two materials because they differ by only 1 count while the system is characterized by ±2 counts of camera noise. With the 0.3 NA 96 TDI camera, a 256 level (8 bit) camera cannot be used because, in both examples, the output is saturated. Thus, no data could be extracted from the camera signal.

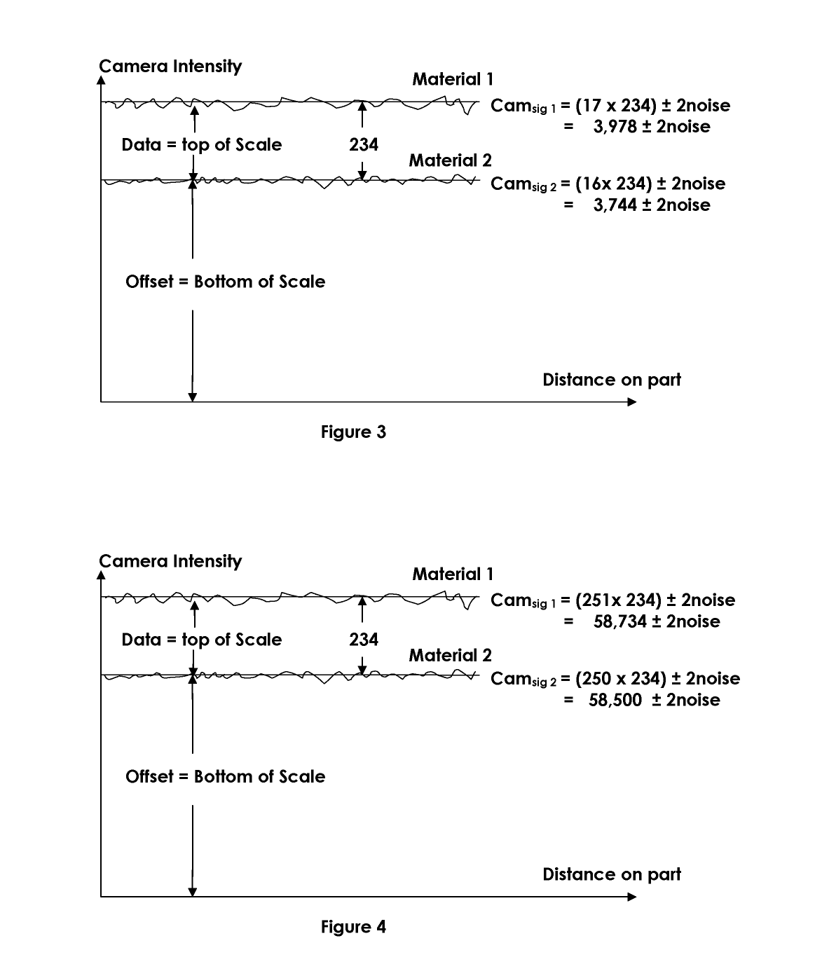

For the first example, signal data reaches 3978 counts which needs at least 12 bits to be represented and in example 2 signal data reaches 65,536 counts which needs at least 16 bits to be represented. Since in each of these examples we are only interested in the upper range of the data, which represents the difference between the two materials, as shown in FIG. 3 for Example 1 and FIG. 4 for Example 2, there are three alternate methodologies for extracting this difference data.

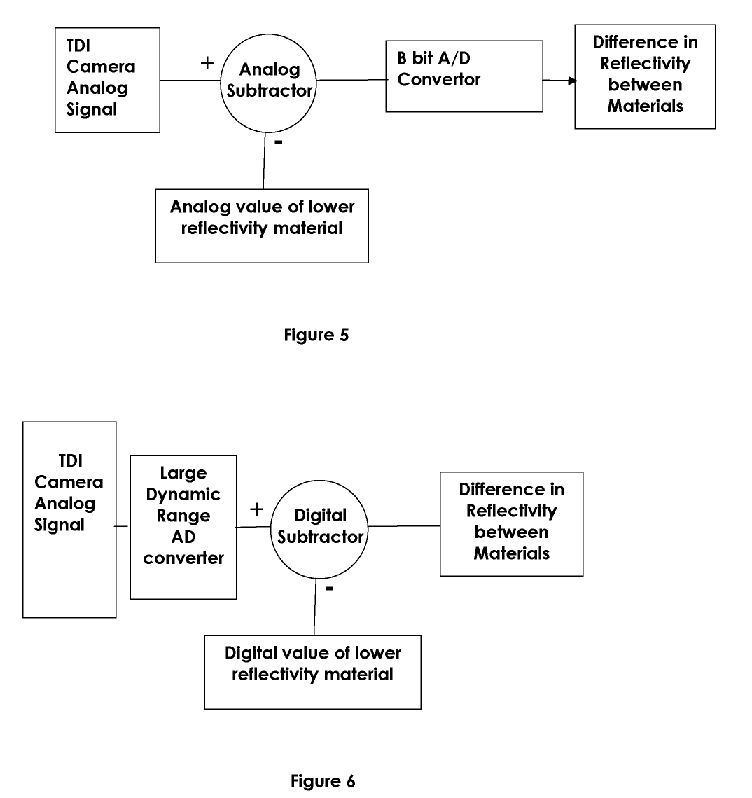

1. Subtract the large offset, shown in FIGS. 3 and 4, in the analog domain. Then place the result after subtraction into a Z-bit analog-to-digital converter to provide 2^{Z} intensity levels as illustrated in FIG. 5 for Z=8 bits (256 intensity levels); or

2. Place the analog data from the camera sensor into an analog-to-digital converter with a dynamic range sufficiently large to accommodate the maximum signal level and process only the data in the top of the dynamic range corresponding to the difference between the materials, as shown in FIGS. 3 and 4. This difference can be obtained by subtracting the offset in the digital domain after conversion by the A/D converter as shown in FIG. 6

3. Combine methods 1 and 2 above by subtracting part of the offset in the analog domain before conversion by the analog-to-digital converter and then subtracting the remaining offset in the digital domain.

### Specific Example of Invention

As will be apparent, it may not be possible to distinguish materials having similar reflectivities in the presence of noise introduced by the camera and processing electronics. Scanning at high speeds exasperates this limitation due to the characteristic limited light and short integration times. This invention overcomes these limitations by increasing the contrast between the materials, without increasing the electronic noise in the system.

More specifically, contrast in increased by:
Using high NA optics and autofocus techniques to collect more light.
Using a TDI CCD camera to increase optical gain without increasing electronic noise.
Processing signals with a large dynamic range in which the reflectivity difference information is in the upper range of the camera or image signal.
Extracting the reflectivity difference information from the large dynamic range signal by:
Subtracting a large offset, corresponding to the minimum reflectivity material, in the analog domain and placing the result after subtraction into an analog-to-digital converter with Z bits where Z bits is sufficient to represent the reflectivity difference information, as shown in FIG. 5; or
Placing the analog data from the camera into an analog-to-digital converter with a sufficient dynamic range to accommodate the maximum signal level, corresponding to the higher reflectivity material and processing only data in the top of the dynamic range corresponding to the reflectivity difference information. One means to extract the reflectivity difference information is to subtract a large offset in the digital domain after conversion by the A/D converter. The value of the offset should be the approximate signal value corresponding to the material of lower reflectivity, as shown in FIG. 6.
Subtracting part of the offset in the analog domain before conversion by an analog-to-digital converter and subtracting the remaining offset in the digital domain.

### Increasing Lamp Life and Adjusting the Optical Gain

In many applications while an optical gain of 1× is too small, an optical gain as large as 234× may not be required for a given application. Adjustment of the optical gain can be achieved by varying the voltage of the illumination lamp, in accordance with equation (15). Reducing lamp intensity also increases lamp life, given by:

LampLife=LampLife*[Vrated/Voperated] (18)

where:
Lamplife=expected lamp life in the actual system;
RatedLife=manufacturers rated life when operated at the manufacturers rated voltage; and
Vrated=Manufacturers rated lamp voltage.

The rated lamp life for a frequently used Osram Model EJV 150 watt quartz halogen lamp is 200 hours. Reducing lamp voltage by only 25% increases lamp life from 200 hours to 1 year.

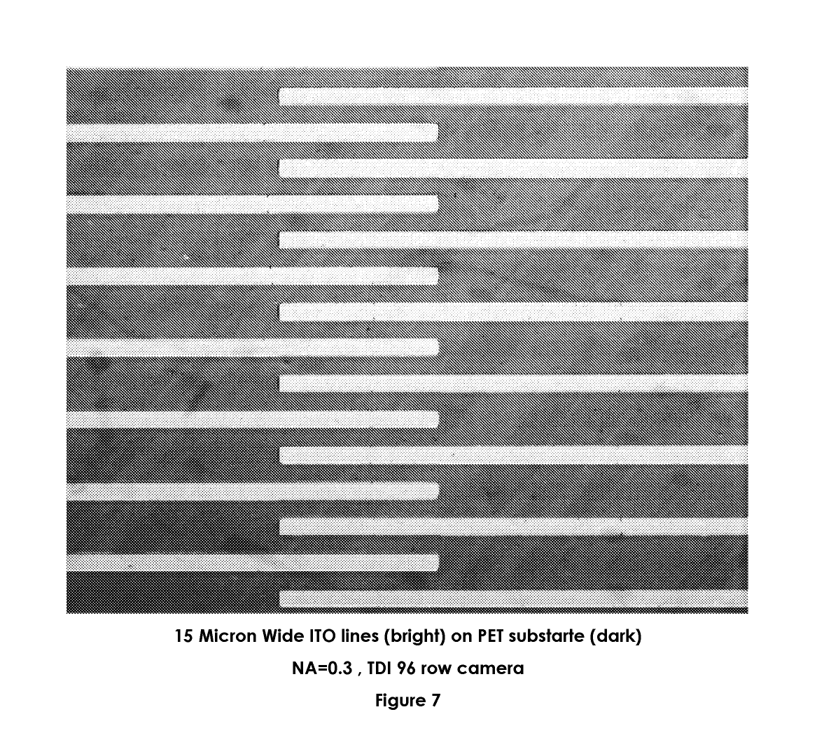

Lamp voltage should be adjusted so that the intensity of the higher reflectivity material is slightly below camera saturation, as illustrated in FIG. 7 which shows the image of an ITO circuit on a PET substrate having different reflectivities. The image was obtained using a 0.3NA lens, in combination with a TDI camera and the top 8 bits of a large dynamic range A/D converter. The bright material in FIG. 7 is the ITO; the dark material is the PET substrate.

As will now be apparent, this invention enables the inspection of parts with different materials having similar optical characteristics, especially similar reflectivities. Moreover, it will be apparent that many substitutions could be made for the specifically disclosed process and apparatus without departing from the spirit and scope of this invention. For example, the disclosed image signal processing involves a subtraction operation; an equivalent result could be obtained by establishing an analog or digital threshold. Therefore, it is the intent of this application to cover all such variations and substitutions.

What is claimed as new is:

1. A method for optically inspecting an electronic part with first and second materials each independently reflecting light with a high signal-to-noise ratio, but with similar reflectivity characteristics, each material being further characterized by exhibiting small variations in reflectivity caused by defects in that material, said method comprising the steps of:
A) illuminating the electronic part in at least an area to be imaged,
B) generating relative motion between the electronic part and an imaging station,
C) generating at the imaging station an image signal from the reflected light using high optical gain and low electrical gain thereby to produce a high-gain, low-noise image signal that is distinctive for light reflected from each of the first and second materials,
D) processing the high-gain, low-noise image signal by subtracting an offset signal having a value based upon the reflectivity of the material with the lesser reflectivity characteristics thereby to generate n-bit digital values representing 2ⁿ intensity levels of the desired output image that distinguish between reflections from each of the materials and that detect defects in the electronic part.

2. A method as recited in claim 1 wherein said image signal generating step includes recording the scanned image with a multiple-row time-delay-and-integrate line scan CCD camera.

3. A method as recited in claim 1 wherein said image signal generating step includes acquiring the image with high numerical aperture optics focused automatically in response to measurements representing the distance between the imaging optics and a location on the electronic part being imaged.

4. A method as recited in claim 3 wherein said image signal generating step includes recording the scanned image with a multiple-row time-delay-and-integrate line scan CCD camera.

5. A method as recited in claim 4 wherein the imaging station generates an analog image signal and said processing thereof includes:
i) generating an analog offset signal,
ii) generating an analog difference signal by subtracting the analog offset signal from the image analog signal, and
iii) converting the analog difference signal into the n-bit digital value.

6. A method as recited in claim 4 wherein the imaging station generates an analog image signal and said processing thereof includes:
i) converting the analog image signal into a digital image signal,
ii) generating a digital offset signal, and
ii) generating a digital difference signal by subtracting the digital offset signal from the digital image signal to generate the n-bit digital value.

7. A method as recited in claim 6 wherein said conversion of the analog image signal into a digital image signal utilizes a analog-to-digital converter that has a given dynamic range, said method including the step of adjusting said illumination to set the image signal from the higher reflectivity material to be within the dynamic range.

8. A method as recited in claim 1 wherein the imaging station generates an analog signal and said processing thereof includes:
i) generating an analog offset signal,
ii) generating an analog difference signal by subtracting the analog offset signal from the analog image signal, and
iii) converting the analog difference signal into the n-bit digital value.

9. A method as recited in claim 1 wherein the imaging station generates an analog image signal and said processing thereof includes:
i) converting the analog image signal into a digital image signal,
ii) generating a digital offset signal,
ii) generating a digital difference signal by subtracting the digital offset signal from the digital image signal to generate the n-bit digital value.

10. A method as recited in claim 9 wherein said conversion of the analog image signal into a digital image signal utilizes a analog-to-digital converter that has a given dynamic range, said method including the step of adjusting said illumination to set the image signal from the higher reflectivity material to be within the dynamic range.

11. Apparatus for optically inspecting an electronic part with first and second materials each independently reflecting light with a high signal-to-noise ratio, but with similar reflectivity characteristics, each material being further characterized by exhibiting small reflectivity differences caused by defects in that material, said apparatus comprising:
A) means for illuminating the electronic part in at least an area to be imaged,
B) means for generating relative motion between the electronic part and an imaging station,
C) means for generating at the imaging station an image signal from the reflected light using high optical gain and low electrical gain thereby to produce a high-gain, low-noise image signal that is distinctive for light reflected from each of the first and second materials,
D) means for processing the high-gain, a low noise image signal by subtracting a signal having a value based upon the reflectivity of the material with the lesser reflectivity characteristics thereby to generate n-bit digital values representing 2ⁿ intensity levels of the desired output image that distinguish between reflections from each of the materials and that detect defects in the electronic part.

12. Apparatus as recited in claim 11 wherein said image signal generating means includes means for recording the scanned image with a multiple-row time-delay-and-integrate line scan CCD camera.

13. Apparatus as recited in claim 11 wherein said image signal generating means includes high numerical aperture optical means for acquiring an image automatically focused in response to measurements representing the distance from said imaging optics to a position on the electronic part being imaged.

14. Apparatus as recited in claim 13 wherein said image signal generating means includes means for recording the scanned image with a multiple-row time-delay-and-integrate line scan CCD camera.

15. Apparatus as recited in claim 14 wherein said imaging station generates an analog image signal and said processing means therefor includes:
i) means for generating an analog offset signal,
ii) means for generating an analog difference signal by subtracting the analog offset signal from the analog image signal, and
iii) means for converting the analog difference signal into the n-bit digital value.

16. Apparatus as recited in claim 14 wherein said imaging station generates an analog image signal and said processing means therefor includes:
i) means for converting the analog image signal into a digital image signal,
ii) means for generating a digital offset signal, and
ii) means for generating a digital difference signal by subtracting the digital offset signal from the digital image signal to generate the n-bit digital value.

17. Apparatus as recited in claim 16 wherein said conversion means includes an analog-to-digital converter that has a given dynamic range, said illumination being adjusted to set the image signal from the higher reflectivity material to be within the dynamic range.

18. Apparatus as recited in claim 11 wherein the imaging station generates an analog signal and said processing thereof includes:
i) means for generating an analog offset signal,
ii) means for generating an analog difference signal by subtracting the analog offset signal from the analog image signal, and
iii) means for converting the analog difference signal into the n-bit digital value.

19. Apparatus as recited in claim 11 wherein the imaging station generates an analog signal and said processing thereof includes:
i) means for converting the analog image signal into a digital image signal,
ii) means for generating a digital offset signal,
ii) generating a digital difference signal by subtracting the digital offset signal from the digital image signal to generate the n-bit digital value.

20. Apparatus as recited in claim 19 wherein said conversion means includes an analog-to-digital converter that has a given dynamic range and said apparatus additionally includes means for adjusting said illumination to set the image signal from the higher reflectivity material to be within the dynamic range.
